(19) United States
(12) Patent Application Publication
(10) Pub. No.: US 2026/0179230 A1
(43) Pub. Date: Jun. 25, 2026

(54) UNIVERSAL CASCADED TRACKERS

(71) Applicant: QUALCOMM Incorporated, San Diego, CA (US)

(72) Inventors: Madhumitha SAKTHI, Dublin, CA (US); Diptiben Navinchandra PATEL, San Diego, CA (US); Shivam AGARWAL, Sunnyvale, CA (US); Amin ANSARI, Kirkland, WA (US)

(21) Appl. No.: 18/991,138

(22) Filed: Dec. 20, 2024

(51) Int. Cl. G06T 7/20

(52) U.S. Cl. CPC G06T 7/20; G06T 2207/20072; G06T 2207/20081; G06T 2207/20084

(57) ABSTRACT

Techniques and systems are provided for object tracking. For instance, a process can include generating a graph based on first information from a first object tracker, second information from an object detector, and previous track query information output from a previous instance of a second object tracker; filtering the graph to remove redundant information from the graph to generate filtered information; and generating new track query information based on the filtered information.

### FIELD

This application is related to object tracking. For example, aspects of the application relate to systems and techniques for universal cascaded trackers.

### BACKGROUND

Systems and devices (e.g., autonomous vehicles, such as autonomous and semi-autonomous cars, drones, mobile robots, mobile devices, extended reality (XR) devices, and other suitable systems or devices) can include multiple sensors to capture information about the environment, as well as processing systems to process the captured information. The captured information can be used for various purposes, such as for virtualization of the environment, virtual object interactions with real objects, route planning, navigation, collision avoidance, etc.

In such systems, sensor data, such as images captured from one or more camera(s), may be captured, transformed, and analyzed to detect objects (e.g., people, animals, vehicles, etc.). In some cases, such systems attempt to detect objects in an environment and track the objects as they move through the environment. Generally, object tracking may be performed using traditional, algorithmic based object trackers, or ML based object trackers. However, existing object trackers may have issues with erratically moving objects, tracking multiple objects, and/or are computational complex. Improved techniques for object track may be useful.

### SUMMARY

Systems and techniques are described herein for object tracking. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for an apparatus for object tracking is provided. For example, an apparatus may include at least one memory and at least one processor coupled to the at least one memory. The at least one processor being configured to: generate a graph based on first information from a first object tracker, second information from an object detector, and previous track query information output from a previous instance of a second object tracker; filter the graph to remove redundant information from the graph to generate filtered information; and generate new track query information based on the filtered information.

As another example, a method for object tracking is provided. The method includes: generating a graph based on first information from a first object tracker, second information from an object detector, and previous track query information output from a previous instance of a second object tracker; filtering the graph to remove redundant information from the graph to generate filtered information; and generating new track query information based on the filtered information.

In another example, a non-transitory computer-readable medium having stored thereon instructions is provided. The instructions, when executed by at least one processor, cause the at least one processor to: generate a graph based on first information from a first object tracker, second information from an object detector, and previous track query information output from a previous instance of a second object tracker; filter the graph to remove redundant information from the graph to generate filtered information; and generate new track query information based on the filtered information.

As another example, an apparatus for object tracking is provided. The apparatus includes: means for generating a graph based on first information from a first object tracker, second information from an object detector, and previous track query information output from a previous instance of a second object tracker; means for filtering the graph to remove redundant information from the graph to generate filtered information; and means for generating new track query information based on the filtered information.

In some aspects, one or more of the apparatuses described herein can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the one or more apparatuses can include at least one camera for capturing one or more images or video frames. For example, the one or more apparatuses can include a camera (e.g., an RGB camera) or multiple cameras for capturing one or more images and/or one or more videos including video frames. In some aspects, the one or more apparatuses can include a display for displaying one or more images, videos, notifications, or other displayable data. In some aspects, the one or more apparatuses can include at least one transmitter configured to transmit data or information over a transmission medium to at least one device. In some aspects, at least one processor of the one or more apparatuses can include a central processing unit (CPU), a digital signal processor (DSP), a graphics processing unit (GPU), a neural processing unit (NPU), a neural signal process (NSP), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure.

FIG. 2 is a diagram illustrating an architecture of a computing system, in accordance with some aspects of the disclosure.

FIG. 3 is a block diagram illustrating an example of a video analysis engine, in accordance with aspects of the present disclosure.

FIG. 4 illustrates operations of a universal cascaded tracker over time, in accordance with aspects of the present disclosure.

FIG. 5 illustrates an example tripartite graph, in accordance with aspects of the present disclosure.

FIG. 6 illustrates a technique for evaluating edges of a tripartite graph, in accordance with aspects of the present disclosure.

FIG. 7 illustrates an example NIL tracking model, in accordance with aspects of the present disclosure

FIG. 8 is a flow diagram illustrating a process for object tracking, in accordance with aspects of the present disclosure.

FIG. 9 is an illustrative example of a deep learning neural network that can be used by a body pose predicting system.

FIG. 10 is an illustrative example of a convolutional neural network (CNN).

FIG. 11 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Increasingly, computer systems are being used to sense an environment in order to perform actions based on the environment, such as maneuvering through the environment, observing the environment for certain conditions, overlaying virtual objects into the environment, etc. In some cases, object detection and object tracking may help allow a computer system to better perceive the environment. Object detection may be performed to detect objects and locate detected objects within a frame. These detected objects may then be tracked. In some cases, to track an object a detected object may be matched (e.g., associated) with a previously tracked object from a previous frame to locate the object within a series of frames.

In some cases, traditional or algorithmic, tracker, such as those based on Kalman filters, may be robust for tracking objects exhibiting linear motion, such as objects on a highway, steady moving objects, etc., but may have difficulties with sudden and/or random motion. In some cases, ML based trackers may work well for more complex scenarios as ML based trackers may consider object features detected in images and use these object features to track objects across images. However, ML based trackers can be, relative to traditional trackers, resource intensive to execute. In some cases, ML based trackers may be combined with traditional, Kalman filter based, trackers to help reduce computational complexity. For example, the ML based tracker may be used for more complex scenes and/or scenes with more complex/random motion. However, combining different trackers may result in redundant bounding boxes and a transform layer may be added to learn to merge redundant bounding boxes, which may increase computational overhead. In some cases, a graph-based technique may be used to reduce redundancy and help combine the different trackers.

Systems, apparatuses, electronic devices, methods (also referred to as processes), and computer-readable media (collectively referred to herein as “systems and techniques”) are described herein for providing a universal cascaded tracker. In some cases, an object detector may detect objects in an obtained image and output object information about the detected object, for example, as first information. The universal cascaded tracker may also obtain information from one or more trackers. For example, a first tracker may be used to generate second information. Information may also be obtained from output of a previous instance of the universal cascaded tracker as previous track query information.

A graph (e.g., a tripartite graph) may be generated using the first information, second information, and previous track query information. In some cases, the first information, second information, and previous track query information may include bounding box information along with either confidence information or uncertainty information. The graph (e.g., the tripartite graph) may be generated by generating a first set of nodes based on the first information, a second set of nodes based on the second information, and a third set of nodes based on the previous track query information. Edges may then be generated among the sets of nodes to connect a node of one set to all of the nodes of the other sets. Cost information may then be determined for the edges. In some cases, the cost of an edge may be based on an intersection over union (IoU) of a first bounding box of the first node, and a second bounding box of the second node, summed with the confidence information and/or inverse of the uncertainty information.

The graph (e.g., the tripartite graph) may then be filtered to remove redundant information, generating filtered information. In some cases, this filtering may be based on the cost of the edges. For example, in an IoU, a higher score may indicate that the bounding boxes are more similar and thus more likely to be redundant. In some cases, if the cost of an edge is more than a merge threshold value, the nodes of the edge may be merged. The filtered information may then be input to a ML tracking model to generate new track query information.

Various aspects of the application will be described with respect to the figures.

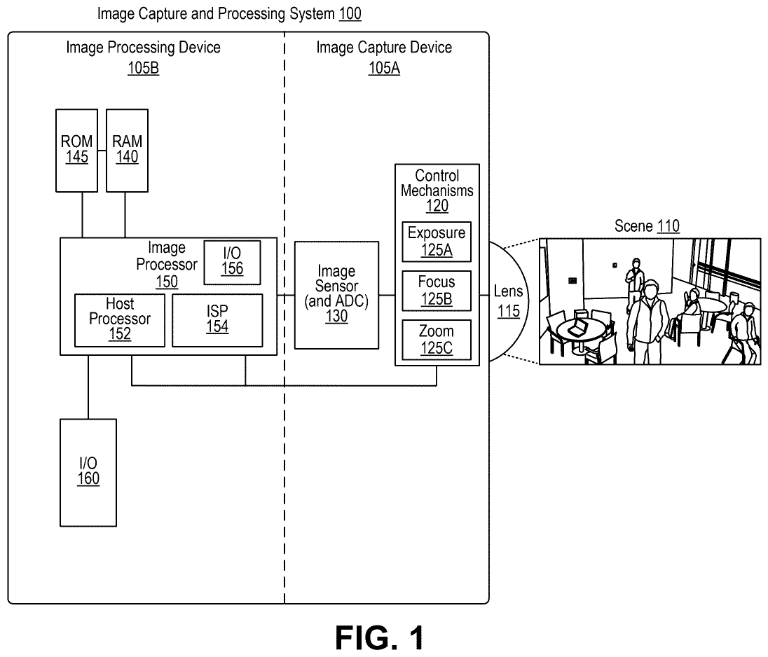

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

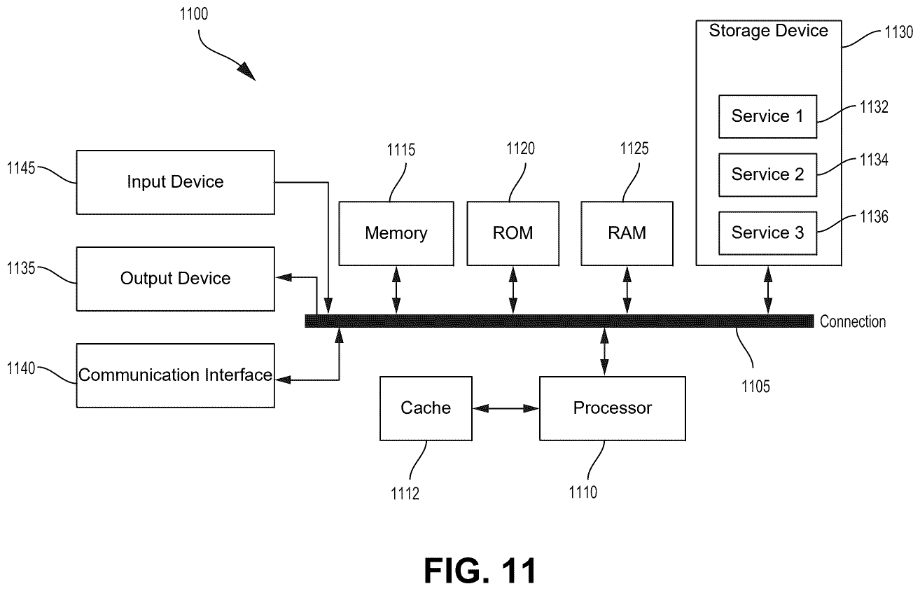

The image processor 150 may include one or more processors, such as one or more image signal processors (ISPs) (including ISP 154), one or more host processors (including host processor 152), and/or one or more of any other type of processor 1110 discussed with respect to the computing system 1100 of FIG. 11. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1035, any other input devices 1045, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

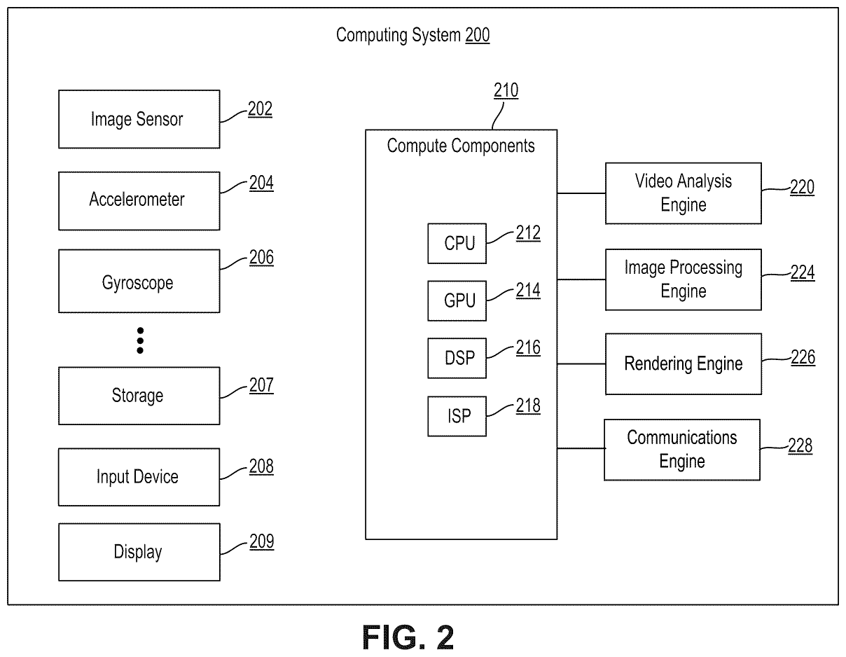

In some examples, the computing system 200 of FIG. 2 can include the image capture and processing system 100, the image capture device 105A, the image processing device 105B, or a combination thereof.

FIG. 2 is a diagram illustrating an architecture of an example computing system 200, in accordance with some aspects of the disclosure. The computing system 200 can run (or execute) various applications for object tracking and/or sensing. In some examples, the computing system 200 can perform tracking and localization, mapping of an environment in the physical world (e.g., a scene), positioning and rendering of virtual content on a display 209 (e.g., a screen, visible plane/region, and/or other display) as part of an XR experience, etc. For example, the computing system 200 can generate a map (e.g., a three-dimensional (3D) map) of an environment in the physical world, track a pose (e.g., location and position) of the computing system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the computing system 200 includes one or more image sensors 202, an accelerometer 204, a gyroscope 206, storage 207, compute components 210, video analysis engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the computing system 200 can include one or more other sensors (e.g., one or more inertial measurement units (IMUs), light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the computing system 200, such as the image sensor 202, may be referenced in the singular form herein, it should be understood that the computing system 200 may include multiple of any component discussed herein (e.g., multiple image sensors 202).

The computing system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, remote body sensor, handheld controller, any other input device 1145 of FIG. 11 discussed herein, or any combination thereof. In some cases, the image sensor 202 can capture images that can be processed for interpreting gesture commands.

The computing system 200 can also communicate with one or more other electronic devices (wired or wirelessly). For example, communications engine 228 can be configured to manage connections and communicate with one or more electronic devices. In some cases, the communications engine 228 can correspond to the communications interface 1140 of FIG. 11.

In some implementations, the one or more image sensors 202, the accelerometer 204, the gyroscope 206, storage 207, compute components 210, video analysis engine 220, image processing engine 224, and rendering engine 226 can be part of the same computing device. For example, in some cases, the one or more image sensors 202, the accelerometer 204, the gyroscope 206, storage 207, compute components 210, video analysis engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, video analysis engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the computing system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the video analysis engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the video analysis engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the video analysis engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the video analysis engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the computing system 200) can be configured to also capture depth information. For example, in some implementations, the image sensor 202 (and/or other camera) can include an RGB-depth (RGB-D) camera. In some cases, the computing system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The computing system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the computing system 200 and can generate acceleration measurements based on the detected acceleration. In some cases, the accelerometer 204 can provide one or more translational vectors (e.g., up/down, left/right, forward/back) that can be used for determining a position or pose of the computing system 200. The gyroscope 206 can detect and measure the orientation and angular velocity of the computing system 200. For example, the gyroscope 206 can be used to measure the pitch, roll, and yaw of the computing system 200. In some cases, the gyroscope 206 can provide one or more rotational vectors (e.g., pitch, yaw, roll). In some examples, the image sensor 202 and/or the video analysis engine 220 can use measurements obtained by the accelerometer 204 (e.g., one or more translational vectors) and/or the gyroscope 206 (e.g., one or more rotational vectors) to calculate the pose of the computing system 200. As previously noted, in other examples, the computing system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the computing system 200, using a combination of one or more accelerometers, one or more gyroscopes, and/or one or more magnetometers. In some examples, the one or more sensors can output measured information associated with the capture of an image captured by the image sensor 202 (and/or other camera of the computing system 200) and/or depth information obtained using one or more depth sensors of the computing system 200.

Sensor data output from one or more sensors (e.g., the image sensor 202, the accelerometer 204, the gyroscope 206, one or more IMUs, and/or other sensors) can be used by the video analysis engine 220 to determine information from the sensor data, such as to detect and/or track one or more objects, determine a pose of the computing system 200 (also referred to as the head pose) and/or the pose of the image sensor 202 (or other camera of the computing system 200), etc. In some cases, the pose of the computing system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track objects in the sensor data and/or to track a pose (e.g., a 6DoF pose) of the computing system 200. For example, the device tracker can fuse visual data (e.g., using a visual tracking solution) from the image data with inertial data from the measurements to determine a position and motion of the computing system 200 relative to the physical world (e.g., the scene) and a map of the physical world.

While the computing system 200 is shown to include certain components, one of ordinary skill will appreciate that the computing system 200 can include more or fewer components than those shown in FIG. 2.

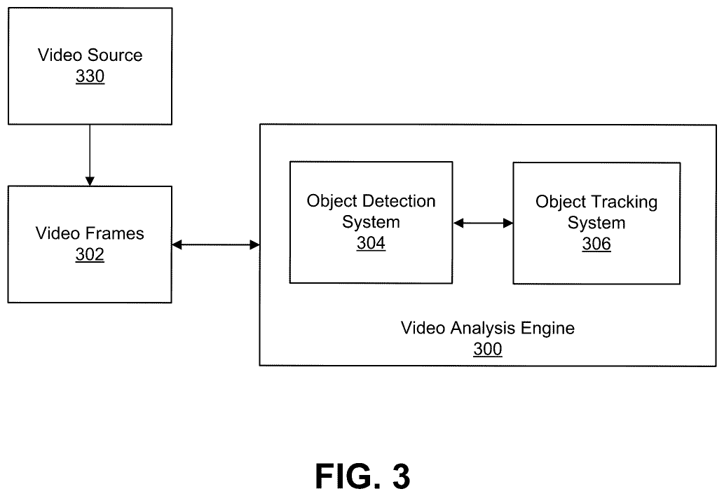

FIG. 3 is a block diagram illustrating an example of a video analysis engine 300. The video analysis engine 300 may be substantially similar to video analysis engine 220 of FIG. 2. In the video analysis engine 300, video frames 302 may be received from a video source 330. The video frames 302 can also be referred to herein as a sequence of frames. Each frame of the video frames 302 can also be referred to as a video picture, image, or a picture. The video frames 302 can be part of one or more video sequences. The video source 330 can include an image capture device (e.g., the image capture and processing system 100, a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 330 can include a camera or multiple cameras. In an illustrative example, multiple cameras can be located on a device and can provide the video frames 302 to the video analysis engine 300. For instance, the IP cameras can be placed at various fields of view around a device to capture views of the environment as the device navigates through the environment based on the captured video frames 302 of the environment.

In some aspects, the video analysis engine 300 and the video source 330 can be part of the same computing device. In some cases, the video analysis engine 300 and the video source 330 can be part of separate computing devices. In some examples, the computing device (or devices) can include one or more wireless transceivers for wireless communications. The computing device (or devices) can include an electronic device, such as a camera (e.g., an camera, video camera, a camera phone, a video phone, or other suitable capture device), a mobile or stationary telephone handset (e.g., smartphone, cellular telephone, or the like), a desktop computer, a laptop or notebook computer, a tablet computer, a vehicle, a robotic device, a set-top box, a television, a display device, a digital media player, a video gaming console, a video streaming device, or any other suitable electronic device.

The video analysis engine 300 includes an object detection system 304 and an object tracking system 306. Object detection and tracking allows the video analysis engine 300 to provide various end-to-end features, such as intelligent motion detection and tracking, intrusion detection, object avoidance, virtual interactions, and other features can directly use the results from object detection and tracking to generate end-to-end events. Other features, such as people, vehicle, or other object counting and classification can be greatly simplified based on the results of object detection and tracking. The object detection system 304 can detect one or more objects in video frames (e.g., video frames 302) of a video sequence, and the object tracking system 306 can track the one or more detected objects across the frames of the video sequence.

As used herein, an object refers to foreground pixels of at least a portion of an object (e.g., a portion of an object or an entire object) in a video frame. For example, an object can include a contiguous group of pixels making up at least a portion of a foreground object in a video frame. In another example, an object can refer to a contiguous group of pixels making up at least a portion of a background object in a frame of image data. An object can also be referred to as a portion of an object, a blotch of pixels, a pixel patch, a cluster of pixels, a blot of pixels, a spot of pixels, a mass of pixels, or any other term referring to a group of pixels of an object or portion thereof. In some examples, a bounding region can be associated with an object. In some examples, a tracker can also be represented by a tracker bounding region. A bounding region of an object or tracker can include a bounding box, a bounding circle, a bounding ellipse, or any other suitably shaped region representing a tracker and/or an object. While examples are described herein using bounding boxes for illustrative purposes, the techniques and systems described herein can also apply using other suitably shaped bounding regions. A bounding box associated with a tracker and/or an object can have a rectangular shape, a square shape, or other suitable shape. For tracking, in case there is no need to know how the object is formulated within a bounding box, the term object and bounding box may be used interchangeably. The object tracking system 306 may track objects using one or more artificial intelligence algorithms, one or more trained ML models, one or more trained neural networks, one or more traditional, algorithmic, (e.g., Kalman filter based) tracking algorithms, or a combination thereof.

As described in more detail below, objects can be tracked using object trackers. An object track for an object can be associated with a tracker bounding box and a tracked object can be assigned a tracker identifier (ID). In some examples, a bounding box for an object in a current frame can be based on the bounding box of a previously detected object in a previous frame. For instance, when the object track is updated in the previous frame (after being associated with the previous object in the previous frame), updated information for the object track can include the tracking information for the previous frame and also one or more predictions for locations of the object in the next frame (which is the current frame in this example). The prediction of the location of the object in the current frame can be based on the location of the object in the previous frame. In some cases, a history or motion model can be maintained for an object track, including a history of various states, a history of the velocity, and a history of location, of continuous frames, for the object track, as described in more detail below.

In some examples, a motion model for an object track can determine and maintain two or more locations of the object for each frame. For example, a first location for an object for a current frame can include a predicted location for the object in the current frame. The first location is referred to herein as the predicted location. The predicted location of the object in the current frame may include/refer to a location of the object in a previous frame (e.g., based on a history or motion model of the object track). Hence, the location of the object associated with the object track in the previous frame can be used as the predicted location of the object and/or object track in the current frame. A second location for the object for the current frame can include a location in the current frame of the object the object track is associated with in the current frame. The second location is referred to herein as the actual location. Accordingly, the location in the current frame of the object associated with the object track is used as the actual location for the object track in the current frame. The actual location of the object track in the current frame can be used as the predicted location for the object/object track in a next frame. The location of the objects can include the locations of the bounding boxes of the objects.

The velocity of an object track can include the displacement of an object track between consecutive frames. For example, the displacement can be determined between the centers (or centroids) of two bounding boxes for the object track in two consecutive frames. In one illustrative example, the velocity of an object track can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the object track in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different over time (e.g., according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

As indicated above, the object tracking system 306 may attempt to associate a detected object with a previously assigned tracker ID to track an object from frame to frame. In some cases, traditional trackers (e.g., algorithmic tracker), such as those based on Kalman filters, may be robust for tracking objects exhibiting linear motion, such as objects on a highway, steady moving objects, etc. However, traditional trackers may have difficulties with sudden and/or random motion as traditional trackers themselves do not consider object features when tracking an object. In some cases, ML based trackers may work well for more complex scenarios as ML based trackers may consider object features in images in order to track objects across images. However, ML based trackers can be, relative to traditional trackers, resource intensive to execute. In some cases, ML based trackers may be combined with traditional, Kalman filter based, trackers to help reduce computational complexity. For example, the ML based tracker may be used for more complex scenes and/or scenes with more complex/random motion. However, combining different trackers may result in redundant bounding boxes and a transform layer may be added to learn to merge redundant bounding boxes, which may increase computational overhead. In some cases, a graph-based technique may be used to reduce redundancy and help combine the different trackers.

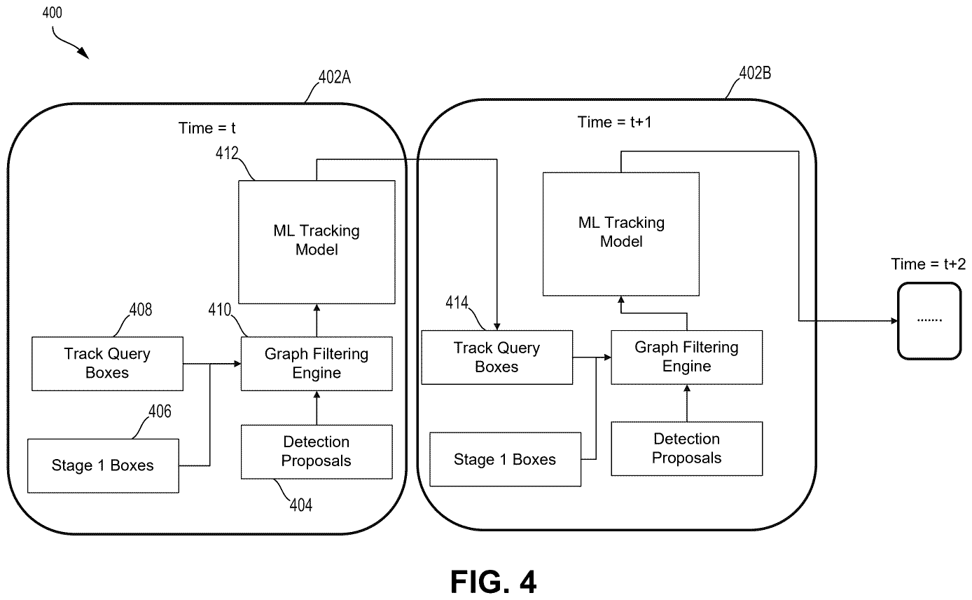

FIG. 4 illustrates operations of a universal cascaded tracker over time 400, in accordance with aspects of the present disclosure. In some cases, a universal cascaded tracker 402A may be included as a part of an object tracking system, such as object tracking system 306 of FIG. 3. In some cases, a graph filtering engine 410 of the universal cascaded tracker 402A may receive object information (e.g., information about a detected object and/or tracked object) from multiple sources. In some cases, the object information may be divided into types based on a source of the object information. For example, as indicated above, bounding box information for detected objects, along with detection confidence information may be generated by an object detector, such as the object detection system 304 of FIG. 3, may be passed into the graph filtering engine 410 for a present time t as a detection proposal 404 type of object information.

In some cases, the universal cascaded tracker 402A may include a plurality of trackers, such as one or more traditional trackers (e.g., algorithmic tracker) as well as one or more ML based trackers. A first tracker may generate, for a present time t, stage 1 boxes 406 type of object information. The first tracker may be a traditional tracker or an ML based tracker. In some cases, the stage 1 boxes 406 may include information about tracked objects by the first tracker. The information included for tracked objects by the stage 1 boxes 406 may include a track identifier, track uncertainty information, and bounding boxes for the previously tracked object.

As an example, a first frame may be received at time t and one or more objects may be detected. In some cases, the detected object may be associated with a track identifier to help identify the object across frames. A bounding box (e.g., bounding box information) for the object may be associated with the object identifier. A confidence score for the track of the object may also be generated and associated with the object identifier. The tracker may output the track identifier, bounding box information, and confidence score (e.g., track uncertainty information) for the stage 1 boxes 406. The object information from the stage 1 boxes 406 may be input to the graph filtering engine 410.

The graph filtering engine 410 may also receive previous track queries (e.g., output from a previous instance of the ML tracking model 412) as track query boxes 408 type of object information. For example, the universal cascaded tracker, at a previous time t−1, may have generated track queries for previously tracked objects. These track queries generated at the previous time may be input to the universal cascaded tracker 402A at a present time t. In some cases, as the track query boxes 408 are generated by at a previous time by the universal cascaded tracker, the track query boxes 408 may include an object identifier, corresponding bounding box information, velocity, track query confidence, etc. for the previously tracked object. In some cases, the track query boxes 408 may be one hot vector encoded.

The detection proposals 404, stage 1 boxes 406, and track query boxes 408 may be input to a graph filtering engine 410. The graph filtering engine 410 may merge (e.g., filter) the input information and use a graph, such as a tripartite graph, to remove (e.g., reduce) redundancy as across the input information (e.g., the detection proposals 404, stage 1 boxes 406, and track query boxes 408) to generate filtered information. The filtered information may then be input to a ML tracking model 412 (e.g., stage 2), such as a multi-object tracking with transformer (MOTR transformer) ML model. The ML tracking model 412 may merge the filtered information and track the detected objects across the frames using, for example, self-attention and deformable attention features. The ML tracking model 412 may output track queries including information about the tracked objects, such as object identifier, corresponding bounding box information, velocity, etc.

The output track queries from the ML tracking model 412 of the universal cascaded tracker 402A at the present time t may be used as track query boxes 414 for input to the universal cascaded tracker 402B at a future time t+1, for example, for continued tracking of the detected objects. In some cases, track queries may be input so long as objects are being tracked across frames and this process may be repeated for every input frame.

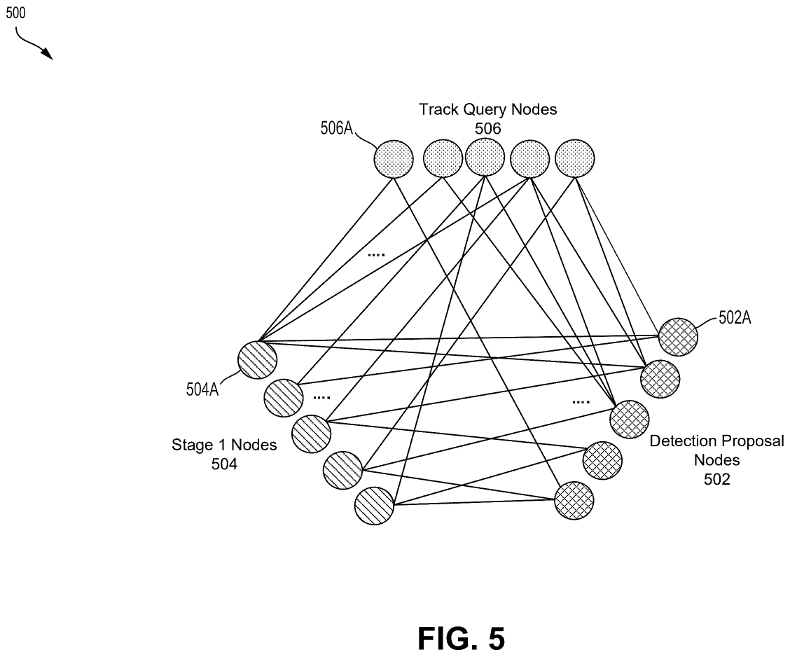

FIG. 5 illustrates an example tripartite graph 500, in accordance with aspects of the present disclosure. In some cases, the graph filtering engine may use a tripartite graph, such as tripartite graph 500, to filter the object information from the received track queries (e.g., from the track query boxes 408 of FIG. 4, stage 1 information (e.g., from the stage 1 boxes 406 of FIG. 4), and detection proposals (e.g., detection proposals 404 of FIG. 4). For example, nodes may be defined based on the detected objects in the information.

In some cases, sets of nodes may be generated based on detected objects (e.g., object information) for the different types of object information (e.g., track query object information corresponding to the track query boxes, stage 1 object information corresponding to the stage 1 boxes, and detection proposal information corresponding to the detection proposals). In FIG. 5, there may be five detected objects in the detection proposal information and object information about each detected object may be represented by a detection proposal node 502 such that each detected object has a corresponding detection proposal node 502. Similarly, the first tracker may have detected five objects in the frame and information from the five detected objects may be placed in corresponding stage 1 nodes 504. Similarly, there may be five previously tracked objects and information about the five previously tracked objects may be placed in corresponding track query nodes 506.

In some cases, edges may be generated (e.g., defined) among nodes of the sets of nodes. For example, each type of node (e.g., where a type of node may be based on how the information contained in the node was obtained, here the first tracker, object detector, and previously tracked objects) may be connected to each node of the other types of nodes by an edge. For example, a detection proposal node 502A may be connected by edges to each of the stage 1 nodes 504 and each of the track query nodes 506. Similarly, a stage 1 node 504A may be connected by edges to each detection proposal node 502 and each track query node 506 and a track query node 506A may be connected by edges to each detection proposal node 502 and each stage 1 node 504.

A cost function for each edge may be defined. In some cases, the cost function may be a generalized intersection over union (GIoU) for the bounding boxes summed with the confidence information and/or uncertainty information. For example, as indicated above, each type of object information may include bounding box information. The GIoU may be performed based on a bounding box associated with a first type of node, such as the first stage 1 node 504A, and a second type of node, such as the first track query node 506A. The GIoU may indicate how much overlap there is between the bounding box of the first stage 1 node 504A and the bounding box of the first track query node 506A. In some cases, the higher the GIoU score, the more overlap between the bounding boxes. Confidence information and inverse uncertainty information may also be summed with the GIoU score. In some cases, an inverse of the uncertainty information may be used to make the uncertainty information comparable with the confidence information. Thus, a cost function for an edge between a stage 1 node 504 and a track query node 506 may be based on the GIoU summed with normalized inverse track uncertainty information and the track query confidence information. In some cases, the track uncertainty information may be normalized as, for example, if the track uncertainty is generated based on multiple objects and/or multiple frames. Similarly, the cost function for an edge between a stage 1 node 504 and a detection proposal node 502 may be based on the GIoU summed with the normalized inverse track uncertainty information and detection confidence information. Similarly, the cost function for an edge between a track query node 506 and a detection proposal node 502 may be based on the GIoU summed with the track query confidence information and the detection confidence information.

In some cases, edges may be collapsed to merge nodes based on the cost function. For example, a higher a cost of an edge, the more overlap there is between the corresponding bounding boxes and the higher the confidence. Thus, the higher the cost of an edge, the more certainty there is that the corresponding nodes are related to the same object. The cost of the edge may be compared to (e.g., a comparison with) a merge threshold value to determine whether to merge nodes. When the cost of an edge is above a merge the threshold value, the corresponding stage 1 node 504 or detection proposal node 502 may be merged into the track query node 506. The lower the cost of an edge, the less overlap there may be for the bounding boxes or the lower the confidence there is. If the cost of an edge is below the merge threshold value, then the corresponding nodes may not be merged as the nodes may describe different objects that should be propagated through the universal cascaded tracker. Determining whether to merge nodes based on the edge cost between the nodes may be performed until there are no edges left, the cost of all the remaining edges are below the merge threshold value, or until a minimum number of nodes (e.g., corresponding to bounding boxes) are reached. In some cases, the merge threshold value may be determined experimentally.

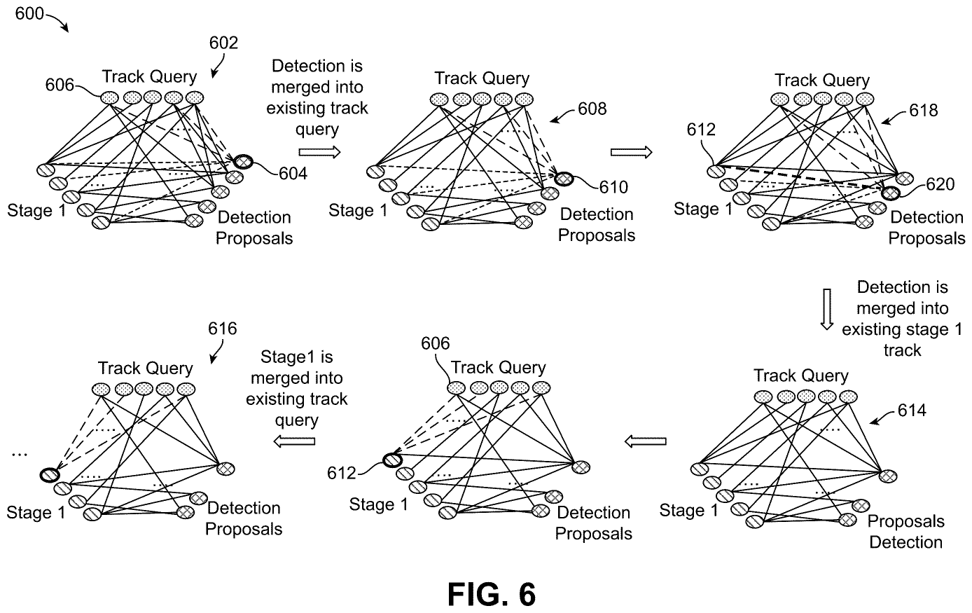

FIG. 6 illustrates a technique 600 for evaluating edges of a tripartite graph, in accordance with aspects of the present disclosure. For a tripartite graph 602 in an initial state, if a cost of an edge between a first detection proposal node 604 and a first track query node 606 may be above a merge threshold value, the first detection proposal node 604 may be merged into the first track query node 606 to obtain the tripartite graph in a second state 608. In some cases, merging a node with another node may be performed based on a weighted average of the bounding box location. For example, a weight corresponding to the detection confidence of the first detection proposal node 604 may be applied to the bounding box information (e.g., location, center) of the first detection proposal node 604 to obtain weighted bounding box information for the first detection proposal node 604. Similarly, weighted bounding box information for the first track query node 606 may be obtained by applying a weight based on the track query confidence value to the bounding box information for the first track query node 606. The weighted bounding box information for the first detection proposal node 604 and the weighted bounding box information for the first track query node 606 may be averaged to obtain updated (e.g., merged) bounding box information for the first track query node 606. The first detection proposal node 604 may then be removed to obtain the tripartite graph in a second state 608.

In the tripartite graph in a second state 608, a determination that the cost of the edges between a second detection proposal node 610 and the track query nodes and stage 1 nodes are not above the merge threshold value may be made and the second detection proposal node 610 may not be merged into another node.

In the tripartite graph in a third state 618, an edge between a third detection proposal node 620 and a first stage 1 node 612 may be above the merge threshold value and the third detection proposal node 620 may be merged into the first stage 1 node 612 in a manner substantially similar to that described above to obtain the tripartite graph in a third state 614. In some cases, as detection proposal nodes represent detected objects, the detection proposal nodes may be more likely merged into other nodes, but other nodes may be less likely to be merged into detection proposal nodes as the detection proposal nodes as detection proposal nodes may represent a detected object without additional details, such as tracking information present in a stage 1 node or track query node.

Similarly, as track query nodes represent previously tracked objects by the universal cascaded tracker, other nodes may be more likely to be merged into track query nodes, while track query nodes may be less likely to be merged into other nodes. Thus, where an edge between the first stage 1 node 612 and the first track query node 606 is above the merge threshold value, the first stage 1 node 612 may be merged into the first track query node 606 in a manner substantially similar to that described above to obtain the tripartite graph in a fourth state 616.

After filtering to merge duplicated bounding boxes (e.g., represented by nodes of the tripartite graph), the remaining bounding boxes may be passed to a ML tracking model to generate object tracking information.

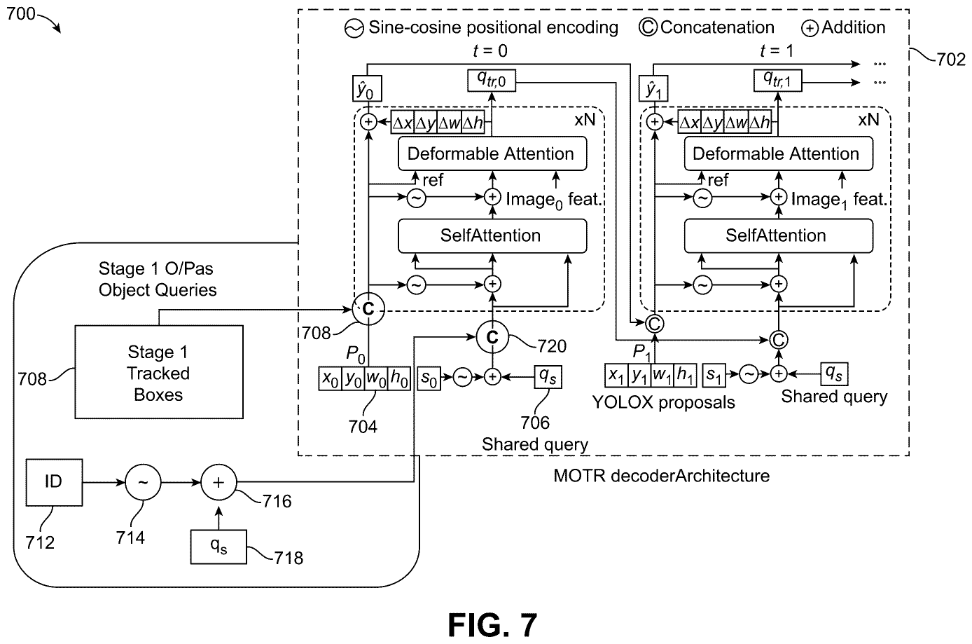

FIG. 7 illustrates an example ML tracking model 700, in accordance with aspects of the present disclosure. In some cases, the ML tracking model 700 may be based on an existing tracking model 702, such as a MOTR transformer. In some cases, an existing tracking model 702 may be configured to receive, as input, bounding box information 704 and query information 706. In some cases, tracking model 702 may be configured so that output of the tracking model 702 may be reinput (e.g., for a next frame) to the tracking model 702 as a part of the bounding box information 704 and query information 706. Thus, the track query nodes from the graph filtering engine may be input as a part of the bounding box information 704 and query information 706.

In some cases, the detection proposal nodes may just include bounding box information and may be input as a part of the bounding box information 704. The stage 1 nodes may include bounding box information 708 as well as track identifiers 712. In some cases, different types of information from the stage 1 nodes may be extracted and reshaped for input to the tracking model 702. For example, stage 1 bounding box information 708 may be extracted and concatenated 710 with the bounding box information 704. In some cases, the track identifiers 712 may be vectorized 714 (e.g., one hot vector encoded) and summed 716 with a shared query 718 that is learned by the tracking model, and concatenated 720 with the query information 706. Integrating the information from the stage 1 nodes may provide additional information for layers of the tracking model 702. For example, a self attention layer 722 and deformable attention layer 724 of the tracking model 702 may merge the detection proposals, existing track queries, and stage 1 information to generate tracking information for an output detection proposal.

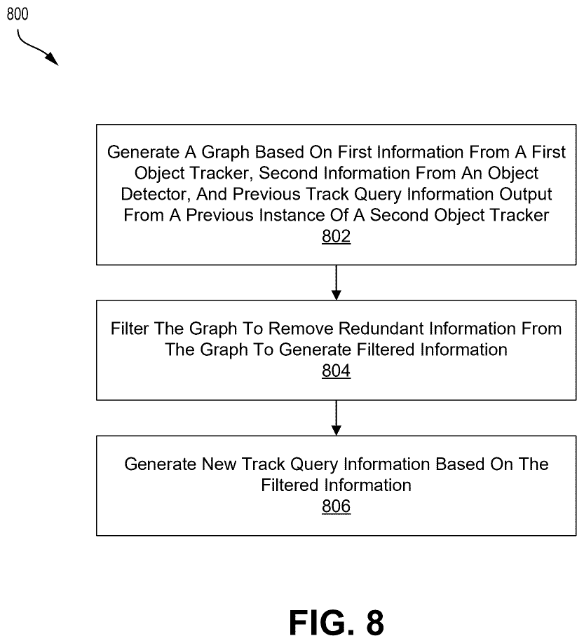

FIG. 8 is a flow diagram illustrating a process 800 for object tracking, in accordance with aspects of the present disclosure. The process 800 may be performed by a computing device (or apparatus) or a component (e.g., a chipset, codec, etc.) of the computing device (e.g., image capture and processing system 100, of FIG. 1, computing system 200 of FIG. 2, video analysis engine 300 of FIG. 3, universal cascaded tracker 402 of FIG. 4, computing system 1100 of FIG. 11, etc.). The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., image processor 150, host processor 152 of FIG. 1, compute components 210 of FIG. 2, processor 1110 of FIG. 11, etc.).

At block 802, the computing device (or component thereof) may generate a graph based on first information (e.g., stage 1 boxes 406 of FIG. 4) from a first object tracker, second information (e.g., detection proposals 404 of FIG. 4) from an object detector (e.g., object detection system 304 of FIG. 3), and previous track query information (e.g., track query boxes 408 of FIG. 4) output from a previous instance of a second object tracker (e.g., ML tracking model 412 of FIG. 4). In some cases, the graph is a tripartite graph (e.g., tripartite graph 500 of FIG. 5). In some examples, the first information, the second information, and the previous track query information include bounding box information and at least one of confidence information or uncertainty information. In some cases, the first object tracker comprises one of a machine learning (ML based) tracker or an algorithmic tracker. In some examples, the second object tracker comprises a multi-object tracking with transformer (MOTR transformer) ML model. In some cases, the computing device (or component thereof) may include a camera. In some examples, the computing device (or component thereof) may generate the first information and second information based on a first image captured by the camera at a present time and generate the previous track query information based on a second image captured by the camera at a previous time.

At block 804, the computing device (or component thereof) may filter the graph (e.g., via graph filtering engine 410 of FIG. 4) to remove redundant information from the graph to generate filtered information. In some cases, the computing device (or component thereof) may filter the graph by determining a cost of an edge between a first node of the second set of nodes and a second node of the third set of nodes and determining to merge the first node into the second node based on the cost of the edge.

At block 806, the computing device (or component thereof) may generate new track query information based on the filtered information. For example, as shown in FIG. 4, output track queries from the ML tracking model of the universal cascaded tracker at the present time t may be used as track query boxes for input to the universal cascaded tracker at a future time t+1. In some cases, the computing device (or component thereof) may generate the graph by generating a first set of nodes (e.g., stage 1 nodes 504 of FIG. 5) based on the first information; generate a second set of nodes (e.g., detection proposal nodes 502 of FIG. 5) based on the second information; generate a third set of nodes (e.g., track query nodes 506 of FIG. 5) based on the previous track query information; and generate edges among the first set of nodes, the second set of nodes, and the third set of nodes. For example, each type of node, of a type of nodes, may be connected to each node of the other types of nodes by an edge. In some examples, the computing device (or component thereof) may determine to merge the first node into the second node based on a comparison of the cost of the edge and a merge threshold value. In some cases, the computing device (or component thereof) may determine the cost of the edge based on an intersection over union (e.g., generalized intersection over union (GIoU)) of a first bounding box of the first node and a second bounding box of the second node summed with at least one of the confidence information or an inverse of the uncertainty information. For example, the GIoU may indicate how much overlap there is between the bounding box of the first node and the bounding box of the second node. In some examples, the computing device (or component thereof) may filter the graph by determining not to merge any additional nodes based on a number of nodes in the graph. For example, merging nodes based on the edge cost between the nodes may be performed until there are no edges left, the cost of all the remaining edges are below the merge threshold value, or until a minimum number of nodes are reached.

As noted herein, the techniques or processes described herein (e.g., the process 800) may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 800 and/or other processes described herein may include a processor, microprocessor, micro-computer, or other component of a device that is configured to carry out the steps of the process 800 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 800 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 800 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

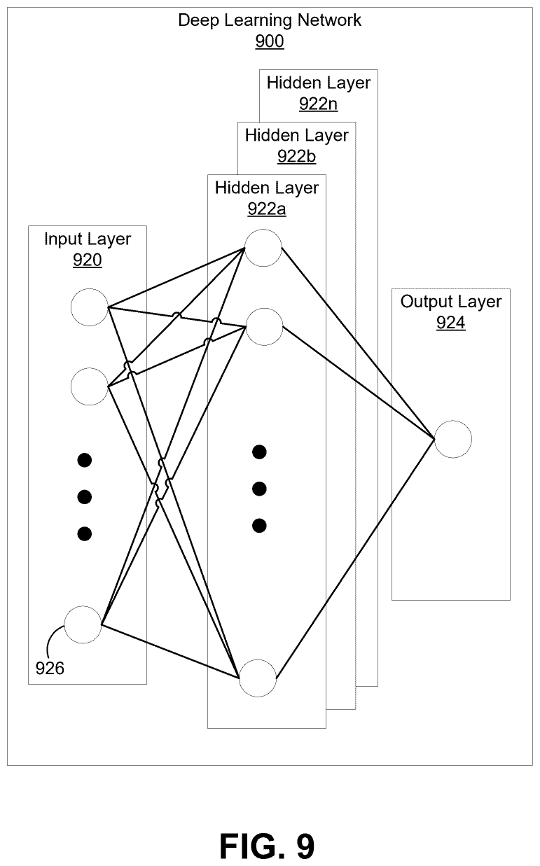

FIG. 9 is an illustrative example of a deep learning neural network 900 that can be used by a body pose predicting system. An input layer 920 includes input data. In one illustrative example, the input layer 920 can include data representing the pixels of an input video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In one illustrative example, the output layer 924 can provide a classification for an object in an input video frame. The classification can include a class identifying the type of object (e.g., a person, a dog, a cat, or other object).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the hidden layers 922a, 922b, through 922n can transform the information of each input node by applying activation functions to the information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify objects in images, the neural network 900 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying objects in images, the forward pass can include passing a training image through the neural network 900. The weights are initially randomized before the neural network 900 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wi denotes the initial weight, and η denotes a learning rate. The learning rate can be set to any suitable value, with a high learning rate including larger weight updates and a lower value indicating smaller weight updates.

The neural network 900 can include any suitable deep network. One example includes a convolutional neural network (CNN), which includes an input layer and an output layer, with multiple hidden layers between the input and out layers. An example of a CNN is described below with respect to FIG. 9. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

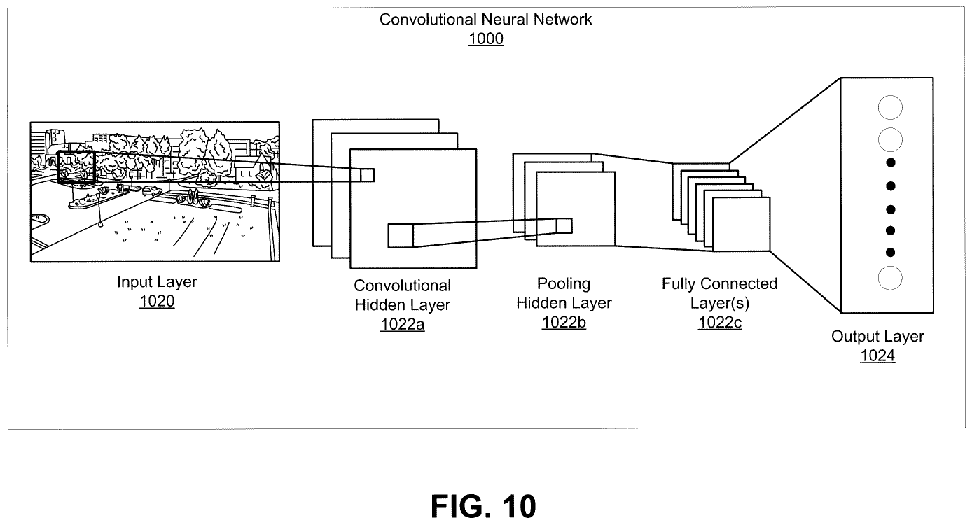

FIG. 10 is an illustrative example of a convolutional neural network (CNN 1000). The input layer 1020 of the CNN 1000 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1022a, an optional non-linear activation layer, a pooling hidden layer 1022b, and fully connected hidden layers 1022c to get an output at the output layer 1024. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 is the convolutional hidden layer 1022a. The convolutional hidden layer 1022a analyzes the image data of the input layer 1020. Each node of the convolutional hidden layer 1022a is connected to a region of nodes (pixels) of the input image called a receptive field. The convolutional hidden layer 1022a can be considered as one or more filters (each filter corresponding to a different activation or feature map), with each convolutional iteration of a filter being a node or neuron of the convolutional hidden layer 1022a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1022a. Each connection between a node and a receptive field for that node learns a weight and, in some cases, an overall bias such that each node learns to analyze its particular local receptive field in the input image. Each node of the hidden layer 1022a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1022a is due to each node of the convolutional layer being applied to its corresponding receptive field. For example, a filter of the convolutional hidden layer 1022a can begin in the top-left corner of the input image array and can convolve around the input image. As noted above, each convolutional iteration of the filter can be considered a node or neuron of the convolutional hidden layer 1022a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1022a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1022a.

The mapping from the input layer to the convolutional hidden layer 1022a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1022a can include several activation maps in order to identify multiple features in an image. The example shown in FIG. 10 includes three activation maps. Using three activation maps, the convolutional hidden layer 1022a can detect three different kinds of features, with each feature being detectable across the entire image.

In some examples, a non-linear hidden layer can be applied after the convolutional hidden layer 1022a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1000 without affecting the receptive fields of the convolutional hidden layer 1022a.

The pooling hidden layer 1022b can be applied after the convolutional hidden layer 1022a (and after the non-linear hidden layer when used). The pooling hidden layer 1022b is used to simplify the information in the output from the convolutional hidden layer 1022a. For example, the pooling hidden layer 1022b can take each activation map output from the convolutional hidden layer 1022a and generates a condensed activation map (or feature map) using a pooling function. Max-pooling is one example of a function performed by a pooling hidden layer. Other forms of pooling functions be used by the pooling hidden layer 1022a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1022a. In the example shown in FIG. 10, three pooling filters are used for the three activation maps in the convolutional hidden layer 1022a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1022a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1022a having a dimension of 24×24 nodes, the output from the pooling hidden layer 1022b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1022b to every one of the output nodes in the output layer 1024. Using the example above, the input layer includes 28×28 nodes encoding the pixel intensities of the input image, the convolutional hidden layer 1022a includes 3×24×24 hidden feature nodes based on application of a 5×5 local receptive field (for the filters) to three activation maps, and the pooling layer 1022b includes a layer of 3×12×12 hidden feature nodes based on application of max-pooling filter to 2×2 regions across each of the three feature maps. Extending this example, the output layer 1024 can include ten output nodes. In such an example, every node of the 3×12×12 pooling hidden layer 1022b is connected to every node of the output layer 1024.

The fully connected layer 1022c can obtain the output of the previous pooling layer 1022b (which should represent the activation maps of high-level features) and determines the features that most correlate to a particular class. For example, the fully connected layer 1022c layer can determine the high-level features that most strongly correlate to a particular class, and can include weights (nodes) for the high-level features. A product can be computed between the weights of the fully connected layer 1022c and the pooling hidden layer 1022b to obtain probabilities for the different classes. For example, if the CNN 1000 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1024 can include an M-dimensional vector (in the prior example, M=8), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some examples, computing system 1100 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, camera, accelerometers, gyroscopes, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some examples, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for object tracking, comprising: at least one memory; and at least one processor coupled to the at least one memory, the at least one processor being configured to: generate a graph based on first information from a first object tracker, second information from an object detector, and previous track query information output from a previous instance of a second object tracker; filter the graph to remove redundant information from the graph to generate filtered information; and generate new track query information based on the filtered information.

Aspect 2. The apparatus of Aspect 1, wherein the graph is a tripartite graph.

Aspect 3. The apparatus of any of Aspects 1-2, wherein the first information, the second information, and the previous track query information include bounding box information and at least one of confidence information or uncertainty information.

Aspect 4. The apparatus of Aspect 3, wherein, to generate the graph, the at least one processor is configured to: generate a first set of nodes based on the first information; generate a second set of nodes based on the second information; generate a third set of nodes based on the previous track query information; and generate edges among the first set of nodes, the second set of nodes, and the third set of nodes.

Aspect 5. The apparatus of Aspect 4, wherein, to filter the graph, the at least one processor is configured to: determine a cost of an edge between a first node of the second set of nodes and a second node of the third set of nodes; and determine to merge the first node into the second node based on the cost of the edge.

Aspect 6. The apparatus of Aspect 5, wherein the at least one processor is configured to determine to merge the first node into the second node based on a comparison of the cost of the edge and a merge threshold value.

Aspect 7. The apparatus of any of Aspects 5-6, wherein the at least one processor is configured to determine the cost of the edge based on an intersection over union of a first bounding box of the first node and a second bounding box of the second node summed with at least one of the confidence information or an inverse of the uncertainty information.

Aspect 8. The apparatus of any of Aspects 4-7, wherein, to filter the graph, the at least one processor is configured to determine not to merge any additional nodes based on a number of nodes in the graph.

Aspect 9. The apparatus of any of Aspects 1-8, wherein the first object tracker comprises one of a machine learning (ML based) tracker or an algorithmic tracker.

Aspect 10. The apparatus of any of Aspects 1-9, wherein the second object tracker comprises a multi-object tracking with transformer (MOTR transformer) ML model.

Aspect 11. The apparatus of any of Aspects 1-10, further comprising a camera, and wherein the at least one processor is further configured to: generate the first information and second information based on a first image captured by the camera at a present time; and generate the previous track query information based on a second image captured by the camera at a previous time.

Aspect 12. A method for object tracking, comprising: generating a graph based on first information from a first object tracker, second information from an object detector, and previous track query information output from a previous instance of a second object tracker; filtering the graph to remove redundant information from the graph to generate filtered information; and generating new track query information based on the filtered information.

Aspect 13. The method of Aspect 12, wherein the graph is a tripartite graph.

Aspect 14. The method of any of Aspects 12-13, wherein the first information, the second information, and the previous track query information include bounding box information and at least one of confidence information or uncertainty information.

Aspect 15. The method of Aspect 14, wherein generating the graph comprises: generating a first set of nodes based on the first information; generating a second set of nodes based on the second information; generating a third set of nodes based on the previous track query information; and generating edges among the first set of nodes, the second set of nodes, and the third set of nodes.

Aspect 16. The method of Aspect 15, wherein filtering the graph comprises: determining a cost of an edge between a first node of the second set of nodes and a second node of the third set of nodes; and determining to merge the first node into the second node based on the cost of the edge.

Aspect 17. The method of Aspect 16, further comprising determining to merge the first node into the second node based on a comparison of the cost of the edge and a merge threshold value.

Aspect 18. The method of any of Aspects 16-17, further comprising determining the cost of the edge based on an intersection over union of a first bounding box of the first node and a second bounding box of the second node summed with at least one of the confidence information or an inverse of the uncertainty information.

Aspect 19. The method of any of Aspects 15-18, wherein filtering the graph comprises determining not to merge any additional nodes based on a number of nodes in the graph.

Aspect 20. The method of any of Aspects 12-19, wherein the first object tracker comprises one of a machine learning (ML based) tracker or an algorithmic tracker.

Aspect 21. The method of any of Aspects 12-20, wherein the second object tracker comprises a multi-object tracking with transformer (MOTR transformer) ML model.

Aspect 22. The method of any of Aspects 12-21, further comprising: generating the first information and second information based on a first image captured by a camera at a present time; and generating the previous track query information based on a second image captured by the camera at a previous time.

Aspect 23: A non-transitory computer-readable medium having stored thereon instructions that, when executed by at least one processor, cause the at least one processor to perform one or more operations according to any of Aspects 12-22.

Aspect 24: An apparatus for object tracking, comprising means for performing one or more of operations according to any of Aspects 12 to 22.

What is claimed is:

1. An apparatus for object tracking, comprising:
at least one memory; and
at least one processor coupled to the at least one memory, the at least one processor being configured to:
generate a graph based on first information from a first object tracker, second information from an object detector, and previous track query information output from a previous instance of a second object tracker;
filter the graph to remove redundant information from the graph to generate filtered information; and
generate new track query information based on the filtered information.

2. The apparatus of claim 1, wherein the graph is a tripartite graph.

3. The apparatus of claim 1, wherein the first information, the second information, and the previous track query information include bounding box information and at least one of confidence information or uncertainty information.

4. The apparatus of claim 3, wherein, to generate the graph, the at least one processor is configured to:
generate a first set of nodes based on the first information;
generate a second set of nodes based on the second information;
generate a third set of nodes based on the previous track query information; and
generate edges among the first set of nodes, the second set of nodes, and the third set of nodes.

5. The apparatus of claim 4, wherein, to filter the graph, the at least one processor is configured to:
determine a cost of an edge between a first node of the second set of nodes and a second node of the third set of nodes; and
determine to merge the first node into the second node based on the cost of the edge.

6. The apparatus of claim 5, wherein the at least one processor is configured to determine to merge the first node into the second node based on a comparison of the cost of the edge and a merge threshold value.

7. The apparatus of claim 5, wherein the at least one processor is configured to determine the cost of the edge based on an intersection over union of a first bounding box of the first node and a second bounding box of the second node summed with at least one of the confidence information or an inverse of the uncertainty information.

8. The apparatus of claim 4, wherein, to filter the graph, the at least one processor is configured to determine not to merge any additional nodes based on a number of nodes in the graph.

9. The apparatus of claim 1, wherein the first object tracker comprises one of a machine learning (ML based) tracker or an algorithmic tracker.

10. The apparatus of claim 1, wherein the second object tracker comprises a multi-object tracking with transformer (MOTR transformer) ML model.

11. The apparatus of claim 1, further comprising a camera, and wherein the at least one processor is further configured to:
generate the first information and second information based on a first image captured by the camera at a present time; and
generate the previous track query information based on a second image captured by the camera at a previous time.

12. A method for object tracking, comprising:
generating a graph based on first information from a first object tracker, second information from an object detector, and previous track query information output from a previous instance of a second object tracker;
filtering the graph to remove redundant information from the graph to generate filtered information; and
generating new track query information based on the filtered information.

13. The method of claim 12, wherein the graph is a tripartite graph.

14. The method of claim 12, wherein the first information, the second information, and the previous track query information include bounding box information and at least one of confidence information or uncertainty information.

15. The method of claim 14, wherein generating the graph comprises:
generating a first set of nodes based on the first information;
generating a second set of nodes based on the second information;
generating a third set of nodes based on the previous track query information; and
generating edges among the first set of nodes, the second set of nodes, and the third set of nodes.

16. The method of claim 15, wherein filtering the graph comprises:
determining a cost of an edge between a first node of the second set of nodes and a second node of the third set of nodes; and
determining to merge the first node into the second node based on the cost of the edge.

17. The method of claim 16, further comprising determining to merge the first node into the second node based on a comparison of the cost of the edge and a merge threshold value.

18. The method of claim 16, further comprising determining the cost of the edge based on an intersection over union of a first bounding box of the first node and a second bounding box of the second node summed with at least one of the confidence information or an inverse of the uncertainty information.

19. The method of claim 15, wherein filtering the graph comprises determining not to merge any additional nodes based on a number of nodes in the graph.

20. The method of claim 12, further comprising:
generating the first information and second information based on a first image captured by a camera at a present time; and
generating the previous track query information based on a second image captured by the camera at a previous time.
